(19) United States
(12) Patent Application Publication
(10) Pub. No.: US 2022/0180293 A1
(43) Pub. Date: Jun. 9, 2022

(54) METHOD AND SYSTEM FOR REAL TIME CONNECTION OF SERVICE SEEKERS WITH ONLINE SERVICE PROVIDERS

(71) Applicants: John Cahalin, San Diego, CA (US); Michael Crawford, Novi, MI (US); Elyse Burden, San Diego, CA (US)

(72) Inventors: John Cahalin, San Diego, CA (US); Michael Crawford, Novi, MI (US); Elyse Burden, San Diego, CA (US)

(21) Appl. No.: 17/114,029

(22) Filed: Dec. 7, 2020

(51) Int. Cl. G06Q 10/06; G06Q 30/02; G06Q 30/06; H04L 29/06

(52) U.S. Cl. CPC G06Q 10/063114; G06Q 30/0201; G06Q 30/0185; H04L 65/1069; G06Q 30/0631

(57) ABSTRACT

Systems and methods for real time connection of service seekers with online service providers are disclosed. The system includes a server configured to establish presence lists corresponding to subject matter and generating live lists of service providers associated with the subject matter. The server is further configured to allow users to select a service provider from the live list and establish a live media session between the user and the service provider in which the service provider is removed from the live list upon selection resulting in remaining service providers ascending the live list in real-time.

### FIELD OF THE INVENTION

The present invention relates generally to the provision of services such as educational services over a communications network, and, more particularly, relates to real time selection and connection of service providers with users.

### BACKGROUND OF THE INVENTION

The Internet has facilitated a great increase in our ability to share information, and likewise to seek out information. Early chat groups and bulletin board systems allowed people to ask questions for things with which they needed help, and hopefully other members of those systems could provide useful information. Many such systems were set up for discussions of particular topics and interests. This allowed people to find online forums to get help from others, and to share their knowledge with others. However, these systems took the form of posting a question and then hoping that, at some point in the future, another person would respond with the desired answer or information.

Since the early days of chat rooms and online forums, other platforms have grown that allow people to seek out information. Video platforms such as YouTube host videos on a very large number of topics from education to home repair to nearly every kind of hobby and interest. People can seek out videos that show them how to make repairs, play music, cook, and thousands of other topics. At this point in time, there is content for virtually every lawful interest available for searching and viewing.

However, these platforms require a person to conduct research in order to find what they are looking for, and even though there is an incredible amount of information available, they may not be able to find something that applies specifically to their particular problem or issue. To remedy this problem, there have been “on demand” systems established where a person can connect in real time with an expert on a given subject to directly communicate with the expert, explain their situation, ask questions, and hopefully receive useful information and instructions. In some of these systems, however, the user is routed to a random expert depending on availability. However, in many cases users would prefer to have to ability to select an expert from the available experts. The selection is often based on credibility criteria, for example, ratings by other users, length of time on the service, number of sessions the expert has been hired for, and many more. In these systems, the user has to hope the selected expert is available after the user selects them. If they are not available, the user has to sit and wait, resulting in frustration for the user and diminished usefulness and enjoyment. Further, because users are attracted to the highest ranked experts, in these prior-art systems, the newer experts have a difficult time getting established due to their being listed too far down the list of experts. The users never even see them as an optional choice. This results in a “catch 22,” as experts with low rankings do not get selected, but they cannot get a higher ranking unless they are selected. As one of the attractions of such a system is having a diverse and large number of experts involved in providing service through the system, a system that encourages and facilitates new experts becoming established would be more beneficial.

In addition, the aforementioned systems typically include one or more mechanisms configured to sustain telecommunication sessions between the expert and the user of the platform soliciting the expert's advice. However, a common issue associated with the aforementioned systems is the mass amount of data collected by the systems and the inability to tag and organize portions of the mass amount of data. For example, during live telecommunication sessions hosted by the platform between the user and the expert, there is a lack of organization of data collected during the sessions. In particular, subjects may be mentioned during the transcript and/or tasks may be assigned from one individual to another in which the aforementioned systems fail to take responsibility for flagging and categorizing components relating to conversations that occurred during the sessions. Thus, a need exists for a subject and task detection mechanism for the systems, along with an organizing mechanism for the aforementioned in real time.

Therefore, a need exists to overcome the problems with the prior art as discussed above.

### SUMMARY OF THE INVENTION

The invention provides a system and method for real time connection of service seekers with online service providers that overcomes the hereinafore-mentioned disadvantages of the heretofore-known devices and methods of this general type and that continuously generates live updated lists including service providers readily available to engage in live media sessions with user of the system. Upon a user selecting a service provider, the selected service provider is immediately removed from the live list and the remaining service providers are continuously moved up the live list thereby increasing the probability of the remaining service providers being viewed and subsequently selected by other users.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer implemented method performed at a server. The computer implemented method also includes establishing, by the server, a plurality of presence lists, where each one of the plurality of presence lists corresponds to a corresponding one of a plurality of defined subject matter categories and indicates a presence status of each one of a plurality of provider entities who provide service corresponding to the subject matter category. The method also includes receiving, at the server, from a remote user client device over a network, a request for presence information for a specific one of the plurality of presence lists. The method also includes the server, responsive to receiving the request for presence information, determining a live list of a plurality of available provider entities based on the presence status of each one of the plurality of provider entities who provide service for the corresponding to the subject matter category as indicated by the specific one of the plurality of presence lists, where the live list only includes ones of the plurality of service provider entities who are presently available. The method also includes serving, by the server, to the remote user client device, the live list to the remote user client device of the network. The method also includes receiving, at the server, from the remote user client device, a selection of a specific one of the plurality of service provider entities who are presently available. The method also includes responsive to receiving the selection of the specific one of the plurality of service provider entities who are presently available, the server establishing a live media session between the remote user client device and the specific one of the plurality of service provider entities. The method also includes responsive to establishing the live media session, altering a presence status of the specific one of the plurality of service provider entities to indicate that the specific one of the plurality of service provider entities is not presently available. The method also includes updating the live list to remove the specific one of the plurality of service provider entities. Other embodiments of this aspect include corresponding computer systems, apparatus, and computer programs recorded on one or more computer storage devices, each configured to perform the actions of the methods.

One general aspect includes a method for exposing service providers to users in an expert communication system. The method also includes at a server, maintaining a presence list of a plurality of service providers that indicates, for each one of the plurality of service providers whether the one of the service providers is presently available or unavailable. The method also includes receiving, at the server, from a remote user client device, a request for a list of service providers. The method also includes in response to the request, the server generating an available presence list of available service providers indicated as being presently available. The method also includes the server serving a hyperlink to the list of available service providers to the remote client device with a script that causes the remote client device to update, in real time, a rendered version of the list of available service providers at the remote client device. The method also includes the server further maintaining, in real time, the available presence list by removing service providers as they become unavailable and adding service providers as they become available. The method also includes where, as a result of maintaining the available presence list, the rendered version of the list of available service providers only includes ones of the plurality of service providers who are presently available, and where ones of the plurality of service providers who included on the rendered version of the list and who become subsequently unavailable are removed in real time from the rendered version of the list. Other embodiments of this aspect include corresponding computer systems, apparatus, and computer programs recorded on one or more computer storage devices, each configured to perform the actions of the methods.

One general aspect includes a system for real time connection of service seekers with online service providers. The system also includes a server designed and configured to. The system also includes establish a plurality of presence lists, where each one of the plurality of presence lists corresponds to a corresponding one of a plurality of defined subject matter categories and indicates a presence status of each one of a plurality of provider entities who provide service corresponding to the subject matter category. The system also includes receive from a remote user client device over a network, a request for presence information for a specific one of the plurality of presence lists. The system also includes determine, responsive to receiving the request for presence information, a live list of a plurality of available provider entities based on the presence status of each one of the plurality of provider entities who provide service for the corresponding to the subject matter category as indicated by the specific one of the plurality of presence lists, where the live list only includes ones of the plurality of service provider entities who are presently available. The system also includes serve to the remote user client device, the live list to the remote user client device of the network. The system also includes receive, from the remote user client device, a selection of a specific one of the plurality of service provider entities who are presently available. The system also includes establish, responsive to receiving the selection of the specific one of the plurality of service provider entities who are presently available, a live media session between the remote user client device and the specific one of the plurality of service provider entities. The system also includes responsive to establishing the live media session, alter a presence status of the specific one of the plurality of service provider entities to indicate that the specific one of the plurality of service provider entities is not presently available. The system also includes update the live list to remove the specific one of the plurality of service provider entities. Other embodiments of this aspect include corresponding computer systems, apparatus, and computer programs recorded on one or more computer storage devices, each configured to perform the actions of the methods.

One general aspect includes a system for exposing service providers to users in an expert communication system. The system also includes a server designed and configured to. The system also includes maintain a presence list of a plurality of service providers that indicates, for each one of the plurality of service providers whether the one of the service providers is presently available or unavailable. The system also includes receive from a remote user client device, a request for a list of service providers. The system also includes in response to the request, generate an available presence list of available service providers indicated as being presently available. The system also includes serve a hyperlink to the list of available service providers to the remote client device with a script that cause the remote client device to update, in real time, a rendered version of the list of available service providers at the remote client device. The system also includes maintain, in real time, the available presence list by removing service providers as they become unavailable and adding service provider as they become available. The system also includes where, as a result of maintaining the available presence list, the rendered version of the list of available service providers only includes ones of the plurality of service providers who are presently available, and where ones of the plurality of service providers who included on the rendered version of the list and who become subsequently unavailable are removed in real time from the rendered version of the list. Other embodiments of this aspect include corresponding computer systems, apparatus, and computer programs recorded on one or more computer storage devices, each configured to perform the actions of the methods.

Although the invention is illustrated and described herein as embodied in a method and system for real time connection of service seekers with online service providers, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a schematic overview representation of an exemplary system for real time connection of service seekers with online service providers;

FIG. 2 is a representation of a dataflow for a system for real time connection of service seekers with online service providers, according to an example embodiment;

FIG. 3A is a graphical user interface presented to a client device illustrating an initial presence list utilized by the system for real time connection of service seekers with online service providers, according to an example embodiment;

FIG. 3B is a graphical user interface presented to a client device illustrating an updated presence list utilized by the system for real time connection of service seekers with online service providers, according to an example embodiment;

FIG. 4 is a block diagram that depicts a process for real time connection of service seekers with online service providers, according to a first example embodiment;

FIGS. 5A-5B are block diagrams that depict a process for real time connection of service seekers with online service providers, according to a second example embodiment;

FIG. 6 is a block diagram that illustrates a computer system upon which an embodiment of the invention may be implemented; and

FIG. 7 is a system diagram of an expert communication system for exposing service providers to users in real time which ensures the service providers are seen by at least some users.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient system and method for real time connection of service seekers with online service providers. Embodiments of the invention provide a centralized platform configured to generate, manage, and update provider presence lists in real time including service providers within subject matter categories to educate and/or assist service seekers. In addition, embodiments of the invention provide mechanisms for establishing live media sessions between a service seeker and a service provider selected by the service seeker while simultaneously removing a service provider from one of the presence lists based on a selection made by the service seeker to establish the live media session with the service provider. Embodiments of the invention allow for service providers to gain increased exposure to service seekers by ascending the presence list once more experienced, more well-known, or just higher listed service providers have been selected by a user of the system on a presence list. The systems and methods described herein provide improvements to aggregation, management, and elimination of data associated with service providers in a scalable manner. By automated aggregation, management, and deletion of service provider data in real time, the system is able to provide users with a scalable method to traverse presence lists based on specific subject matter categories while the system simultaneously eliminates the presence of service providers that are not available due to their participation in a live media session resulting in live curated presence lists that previously would have required manual management. In addition, the systems and methods described herein account for a detect, flag, and categorize mechanism associated with a server configured to generate a timeline based off of a transcript of the live media session allowing a user to analyze tags, associations, and other applicable data relating to one or more components of the transcript. Thus, the system and methods described herein improve the functioning of computing systems by organizing and optimizing big data processing via automated aggregation, management, and deletion of currently unavailable service providers within a specific subject matter category in a manner that accommodates users of networks with large quantities of data.

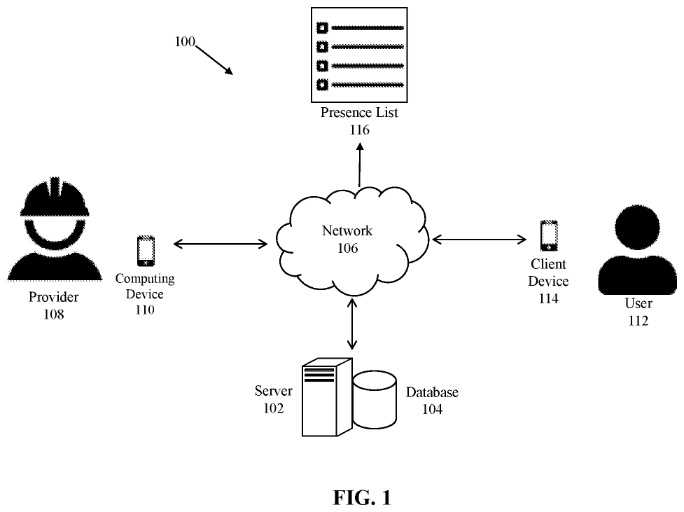

Referring now to FIG. 1, a system 100 for real time connection of service seekers with online service providers is depicted, according to an exemplary embodiment. In one embodiment, system 100 includes a server 102 coupled to a database 104, a communicative network 106, a plurality of service provider entities, hereinafter referred to as provider 108, operating on a computing device 110, a user 112 operating on a client device 114 wherein each of the aforementioned components are communicatively coupled via network 106. It will be understood by those skilled in the art that provider 108, device 110, user 112, and device 114 can be substantially duplicated for other providers and users in the system 100, which is a computer-based system. The various components of system 100 are implemented at least partially by hardware at one or more computing devices, such as one or more hardware processors executing instructions stored in one or more memories for performing various functions described herein. For example, descriptions of various components (or modules) as described in this application may be interpreted by one of skill in the art as providing pseudocode, an informal high-level description of one or more computer structures. The descriptions of the components may be converted into software code, including code executable by an electronic processor. System 100 illustrates only one of many possible arrangements of components configured to perform the functionality described herein. Other arrangements may include fewer or different components, and the division of work between the components may vary depending on the arrangement. Although only a single server 102, database 104, computing device 106, and client device 114 are depicted, system 100 may include multiple servers and databases that interact with network 106 and that provide services to multiple computing devices both within and outside of system 100. In some embodiments the server 102 and database 104 can represent abstractions of computing equipment provided in a data center such as, for example, that provided by Amazon Web Services. Examples of computing devices include a laptop computer, a tablet computer, a smartphone, a desktop computer, a Personal Digital Assistant (PDA), and any other mechanism including a processor used to access the internet or on which application programs can be run. It is to be understood that server 102 is configured to deploy executable software which includes a provider side configured to operate on computing device 110 and a user side configured to operate on client device 114. An example of an application includes a dedicated software that is installed and executed on computing device 110 and client device 114 that is configured to communicate with server 102 over network 106. Another example of an application is a web application that is downloaded from server 102 and that executes within a web browser executing on computing device 110 and/or client device 114. Server 102 may be implemented in hardware, software, or a combination of hardware and software. Network 106 may be implemented as a Local Area Network (LAN), Wide Area Network (WAN), Ethernet or the Internet, one or more terrestrial, satellite or wireless links, or any medium or mechanism that provides for the exchange of data between the aforementioned components of system 100. In one embodiment, server 102 may collect, over network 106, data sourced from entities outside of system 100 configured to be integrated into data collected within system 110. For example, server 102 may be configured to receive validation and/or authentication of accreditation and accolades of provider 108 from an entity outside of system 100 in order to ensure that provider 108 is not misrepresenting their identity or qualifications to user 112. For the purposes of this specification, the term, ‘data’ is meant to include all forms of data, text, image, audio, hyperlink, video and metadata.

It is to be understood that server 102 can be updated in real time with data received via network 106, and server 102 is further configured to store received data in database 104 as records and retrieve data from said records in real time. In some embodiments, server 102 may generate a provider profile associated with provider 108 including a plurality of provider data and a user profile associated with user 112 including a plurality of user data. Examples of provider data can include, but is not limited to, name of provider 108, contact information of provider 108, verified accreditation and qualifications of provider 108, subject matter categories for listed services based on qualifications associated with provider 108, geographic location of provider 108, history and ratings of live media sessions conducted within system 100 involving provider 108 based on feedback of user 112, and any other applicable information configured to assist user 112 in selecting the optimal provider 108 for desired professional services. Examples of user data can include, but is not limited to, user name, contact information, geographic location of user 112, history of subject matter categories searched for within system 100 by user 102, reviews of professional services rendered to user 112 on system 100, rating of user 112 provided by provider 108 subsequent to a live media session, or any other applicable data associated with user 112.

In some embodiments, server 102 is configured to collect, in real time, user activity data associated with user 112 from client device 114 exposing metadata associated with the usage of client device 114 by user 112. For example, server 102 can be configured to collect metadata associated with social media activity of user 112 on client device 114 in order for server 102 to automatically determine applicable subject matter categories to suggest to user 112 for presence lists. In one embodiment, server 102 is configured to receive data in real time from computing device 110 and client device 114 in order to perform analytics and micro-analytics associated with search terms utilized by user 102, search patterns on system 100 associated with user 112, and subject matter categories determination based on internet browsing, social media activity, and other applicable operations performed by user 112 on client device 114. For example, if metadata associated with client device 114 indicates that user 112 has been actively searching for bathroom remodeling, such as by browsing of social media content containing bathroom modeling, then server 102 can automatically associate and suggest lists including contractors that specialize in bathroom modeling. In one embodiment, server 102 is further configured to generate a one or more presence lists 116 wherein each presence list 116 is associated with a specific subject matter category and configured to be continuously updated in real-time based on aggregation and addition of available providers 108 in addition to deletion or elimination of providers 108 due to preoccupancy with live media session with other users of system 100. Examples of subject matter categories may include, but are not limited to, medical, legal, accounting, contracting, architecture, consulting, technology, real estate, and any other applicable industry, trade, or profession that requires a qualified, trained, and authenticated professional. It is to be understood that server 102 provides a centralized network configured to support verification from third party entities of qualifications associated with provider 108 in order to assure user 112 that provider 108 is legally competent and qualified to render advertised services. Server 102 provider user interfaces to client device 114 requesting information from user 112 such as which subject matter categories apply to user 112 and based on the response of user 112 accessed database 104 to retrieve provider records associated with the specific subject matter category in order to generate presence lists 116. In one embodiment, presence list 116 is configured to support an indication of a presence status of each one of provider 108 of the service provider entities who provide service corresponding to the subject matter category and user 112 may generate a request for presence associated with a specific subject matter category in order to retrieve availability of providers 108 within presence lists 116 associated with the specific subject matter category. For example, user 112 may indicate to server 102 that user 112 is in search of an intellectual property attorney; however, user 112 is unsure as to what type of intellectual property attorney is needed in which server 102 will generate a plurality of presence lists 116 wherein a first presence list includes only patent attorneys, a second presence list includes only trademark attorneys, a third presence list includes copyright attorneys, and a fourth presence list includes trade secret specialist attorneys. User 112 may generate a presence request for one of the aforementioned presence lists in which server 102 provides a live presence list 116 indicating a plurality of providers each of which are ranked and allocated among presence list 116 and are available for selection by user 112. It is to be understood that a specific provider may be qualified to be included on more than one presence list at a time in which server 102 is configured to eliminate the specific provider from all of the presence lists the specific provider is included on once the specific provider is selected by user 112. In some embodiments, the system 100 can maintain presence lists in an ongoing manner as providers (e.g. provider 108) become available or unavailable, such as by establishing a session with server 102, entering into private communications with a user (e.g. user 112), or terminating a session with server 102. When users connect to the server 102, based on information they provide, either through prompting, searches, retrieved metadata, etc. they can receive presence list content to be rendered on their device (e.g. device 114), allowing them to see some information about the providers who are presently available, and a hyperlink to a respective resource page for each provider that allows a user to see more details about a provider. The presence list 116, as rendered at the client device 114, can also include a hyperlink to allow the user to select a provider in order to initiate a private communication session with the provider. The rendering of the presence list 116 at the client device 114 can be done by providing a subset of all of the available providers if the number of providers is greater than some preselected threshold number of providers. In some embodiments, a user or a set of users can be shown one subset of providers, while a different user or different set of users can be shown a different subset of providers of the total presence list 116. Thus, rather than show all users the same providers, different users or sets of users will see a different rendering of available providers. Alternatively, the presence list 116 can be rendered in a different order at each user device 114, or subset of user devices. Thus helps ensure, when there are a substantial number of available providers, the providers are exposed to users. In a further alternative, the providers can be rendered in a “first in, first selected out” format so that providers that have been available the longest rise to the front or top of the presence list rendering at the user device 114.

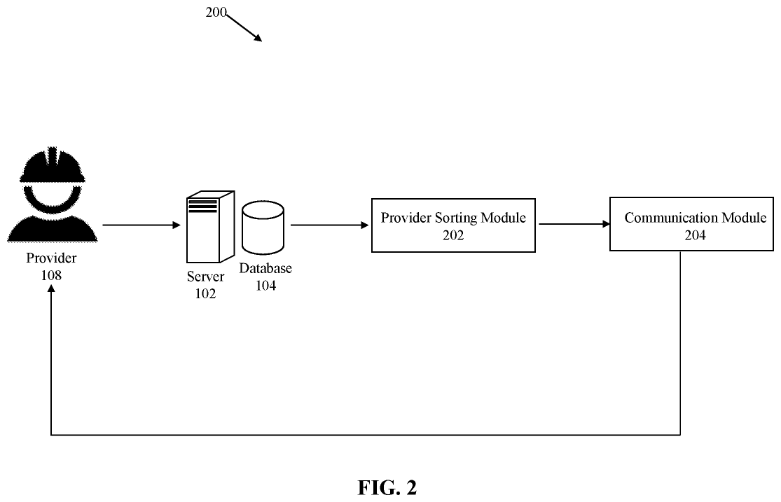

Referring now to FIG. 2, an exemplary data flow 200 utilized by system 100 is depicted, according to an exemplary embodiment. In one embodiment, system 100 further comprises a provider sorting module 202 configured to manage and determine placement of provider 108 on presence list 116, and a communication module 204 configured to facilitate live media sessions between provider 108 and user 112 over network 106. It is to be understood that provider sorting module 202 operates on a foundational level with the purpose of ensuring that each of providers 108 included on each of the plurality of presence lists 116 are available for selection by user 112, otherwise server 102, in combination with provider sorting module 202 or alone, eliminates the provider that is not available from presence lists 116. In one embodiment, communication module 204 is configured to safely and securely communicate transmissions of signals between computing device 110 and client device 114 over network 106, wherein transmissions may be video content/streaming, chat data, text data, or any other applicable type of data utilized to transmit text, audio, and video chat data that may be presented on a computing device. Communication module 204 may be communicatively coupled to provider sorting module 202 in order for server 102 to determine if provider 108 is engaged in a live media session hosted by communication module 204 prior to including provider 108 on any of the plurality of presence list 116. While communication module 204 is operating the live media sessions between providers and users, server 102 is continuously interacting with communication module 204 and monitoring to ensure that none of providers 108 are engaged in a live media session while simultaneously being included on any of presence lists 116. It is to be understood that server 102 is actively streaming and updating presence lists 116 with providers 108 in real time while actively removing providers 108 from presence lists 116 upon server 102 detecting communication module 204 being utilized by providers 108.

In one embodiment, provider sorting module 202 is further configured to manage the placement of a particular provider 108 on each presence list of the plurality of presence list 116. For example, provider 108 may be an intellectual property attorney configured to provide services and/or advice relating to patents, trademarks, copyrights, and trade secrets; however, provider 108 may specialize particularly in patents resulting in provider being included in a first presence list wherein the subject matter category is patents, a second presence list wherein the subject matter category is trademarks, a third presence list wherein the subject matter category is copyrights, and a fourth presence list wherein the subject matter category is trade secrets. Each one of these presence lists may have provider 108 listed if he practices within the respective area; however, the placement of provider 108 will be subject to server 102, alone or in combination with provider sorting module 202, meaning that because provider 108 of the previous working example specializes in patent law, that the position of provider 108 in the first presence list would be higher than the position of provider 108 in the other presence lists. Provider sorting module 202 is configured to sort providers 108 within the respective presence list of the plurality of presence lists 116 based on the rating, ranking, and/or competency of provider 108. In one embodiment, sorting of providers 108 may be accomplished based primarily on experience and secondarily on geographic location of provider 108 in respect to user 112 (location of client device 114). For example, a provider with more years of experience associated with the specific subject matter category of the applicable presence list will be listed significantly higher than a provider with less years of experience; however, once communication module 204 attempts to initiate a live media session with computing device 110 based on the more experienced provider being selected by user 112 server 102 removes the more experienced provider from the applicable presence list allowing the less experienced provider to ascend the applicable presence list increasing the probability of the less experienced provider being viewable and selected by another user of system 100.

In a working example, provider 108 enters provider data to a user interface depicted on computing device 110 provided by server 102. Server 102 generates the provider profile based on the received provider data and stores the provider profile into a provider record housed in database 104. In one embodiment, provider 108 may designate applicable specific subject matter categories associated with their skills, credentials, and services by providing said information to server 102, or server 102 may automatically determine specific subject matter categories associated with provider 108 via utilizing provider sorting module 202. For example, user 112 may indicate that he or she is in search of an intellectual property attorney by specifying intellectual property attorney for the subject matter category, in which the provider profile of provider 108 may indicate that provider 108 is an intellectual property attorney wherein the provider profile includes a verified United States Patent & Trademark Office patent registration number indicating that provider 108 is eligible to practice patent law; thus server 102 is configured to search database 104 to pull the provider record associated with provider 108 and utilize provider sorting module 202 to include provider 108 on any of presence lists 116 that relates to patent law. Due to the fact that it is possible for provider 108 to be included on more than one presence list a given time, it is to be understood that once server 102 detects communication module 204 interacting with computing device 110 provider 108 is removed from each presence list of the plurality of presence lists 116 resulting in the remaining providers listed below provider 108 to ascend on the presence list.

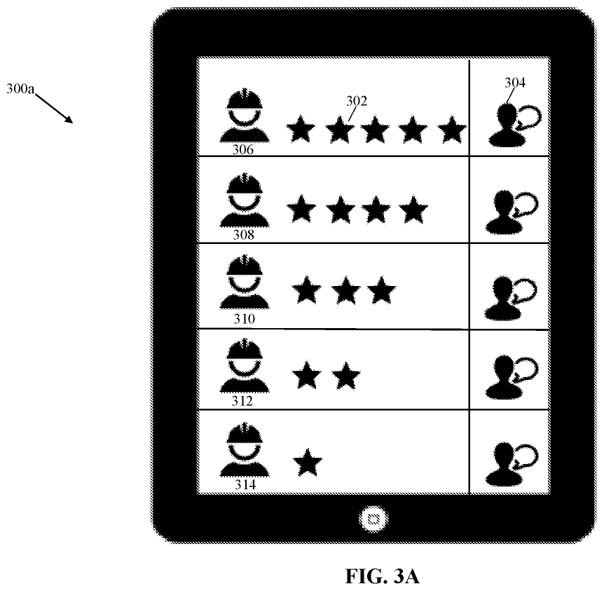

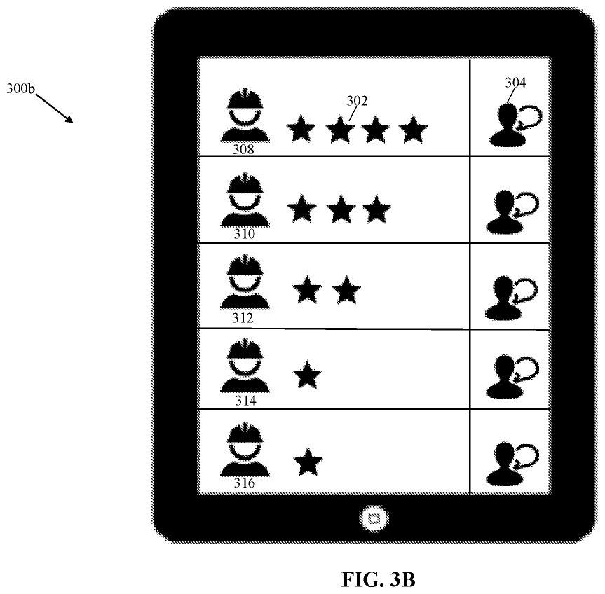

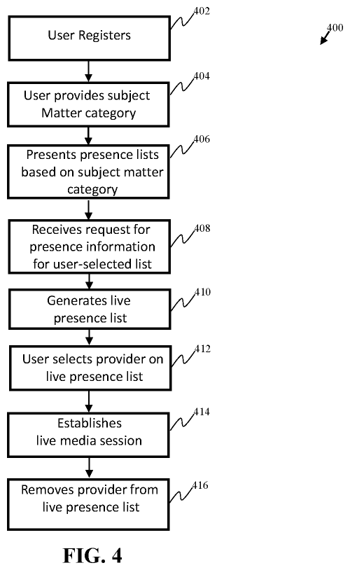

Referring now to FIGS. 3A-4, a first user interface 300a illustrating an exemplary initial presence list 116 in FIG. 3A, a second user interface 300b illustrating an exemplary updated presence list 116 in FIG. 3B, and a first flow chart 400 illustrating a method for real time connection of service seekers with online service providers is depicted in FIG. 4, according to an exemplary embodiment. At step 402, user 112 registers with system 100 by providing login credentials on client device 114 via a login user interface provided by server 102 or if user 112 is an preexisting user of system 100 user 112 is prompted by server 102 for submission of a subject matter category. At step 404, user 112 provides a subject matter category to a subject matter category submission user interface depicted on client device 114 allowing server 102 to access database 104 and search for applicable provider records to be presented in applicable presence lists based on the subject matter category submission. In one embodiment, based on the submitted one or more subject matter categories along with the geographic location of client device 114, server 102 accesses and searches database 104 for provider records associated with the one or more subject matter categories and retrieves the applicable provider records for inclusion in the applicable presence lists. At step 406, server 102 presents the plurality of applicable presence lists 116 based on the provided subject matter categories in which each of presence lists 116 include live and currently available providers 108. In a working example, user 112 submits a subject matter category relating to home construction/renovation in which server 102 provides a first presence list for house structure remodeling providers, a second presence list for interior designers, a third presence list for bathroom designers, and a fourth presence list for carpenters. It is to be understood that there is no limit on the amount of presence lists that may be associated with a specific subject matter category and that it is possible for a particular provider 108 to be included on more than one presence list subject to qualifications. However, in one embodiment, server 102 may establish a preselected maximum number of providers 108 to be included on each presence of the plurality of presence lists 116, wherein the preselected maximum number may be selected based on criterion provided by user 112 or the overall amount of available providers 108 that are within a defined proximity of user 112. In one embodiment, one or more live lists may be generated by server 102 based on presence lists 116 in which the live lists indicate the presence status associated with each provider listed on presence lists 116. In each presence list 116 only providers that are presently available are displayed. Providers that are not logged onto the system or engaged with other users, or determined to be dormant or away from their computing device, are not shown in the presence lists 116. At step 408, client device 114 transmits to server 102 the selection of the preferred presence list 116 along with a presence request for the presence of applicable providers 108. At step 410, server 102 generates an initial presence list, as depicted in user interface 300a of FIG. 3A, including a ranking mechanism 302, a communication interaction selectable option 304 configured to trigger communication module 204, a highest ranked provider 306, a second highest ranked provider 308, a third highest ranked provider 310, a fourth highest ranked provider 312, and a fifth highest ranked provider 314 each of which are depicted in a vertically scrollable arrangement wherein as user 112 scrolls up user interface 300a lower ranked providers are continuously aggregated and presented.

In one embodiment, user 112 can manually remove providers from user interface 300a via a horizontal swipe motion along the name or ranking of the applicable provider in which the removed provider is immediately replaced by the provider listed directly below the removed provider allowing the presence list and/or live list to continuously receive new providers if available resulting in lower ranked providers consistently moving up as higher ranked providers are selected. It is to be understood that ranking mechanism 302 may be any applicable mechanism configured to indicate distinctions between providers 108. In one embodiment, ranking mechanism 302 may be a numerical score allocated to provider 108 based on the experience of the provider and feedback from other users of system 100 or ranking mechanism may be any applicable icons or symbols configured to reflect a distinction between providers 108. In one embodiment, server 102 and provider sorting module 202 are configured to organize the one or more presence lists solely based on ranking mechanism 302. At step 412, user 112 selects provider 108 via interacting with communication interaction selectable option 304 triggering communication module 204 to initiate a live media session. In this working example, user 112 selects highest ranked provider 306 via interacting with communication interaction selectable option 304; however, it is to be understood that selection of provider 108 by user 112 may be accomplished by any applicable method known by one of ordinary skill in the art. At step 414, communication module 204 establishes a secure and encrypted live media session between computing device 110 and client device 114. In one embodiment, the live media session may be a video conference, chat portal, or any other applicable form of secure transmission of signals known to those of ordinary skill of the art. At step 416, server 102 removes provider 108 from the presence list, as illustrated in updated presence list user interface 330b depicting highest ranked provider 306 removed from the presence list due to communication module 204 establishing a live media session with the computing device associated with highest ranked provider 306 based on selection of highest ranked provider 306 by user 112. In addition, second highest ranked provider 308 moves to the position of highest ranked provider 306, third highest ranked provider 310 moves to the position of second highest ranked provider 308, fourth highest ranked provider 312 moves to the position of third highest ranked provider 310, fifth highest ranked provider 314 moves to the position of fourth highest ranked provider 312, and a new lowest ranked provider 316 moves into the position of fifth highest ranked provider 314.

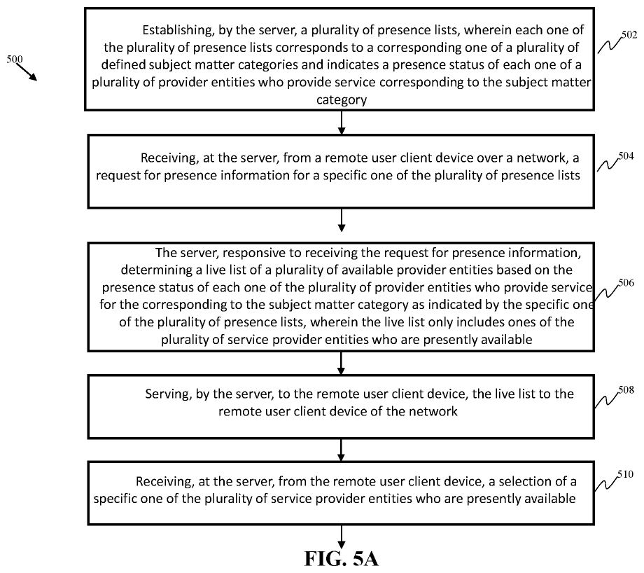

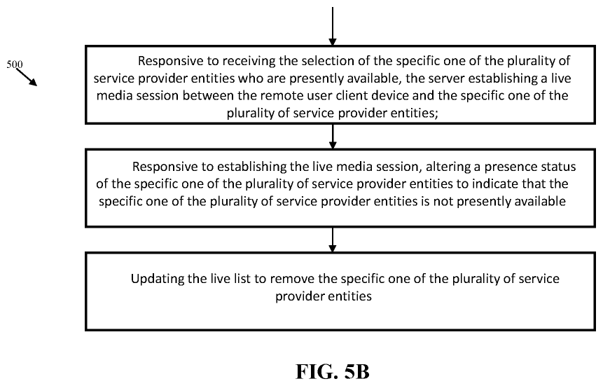

Referring now to FIGS. 5A-5B, a second flow chart 500 illustrating a method for real time connection of service seekers with online service providers are depicted, according to an exemplary embodiment. At step 502, server 102 establishes a plurality of presence lists 116, wherein each one of the plurality of presence lists 116 corresponds to a corresponding one of a plurality of defined subject matter categories and indicates a presence status of each one of a plurality of provider entities (providers 108) who provide service corresponding to the subject matter category. At step 504, server 102 receives from client device 114 a request for presence information for a specific one of the plurality of presence lists 116 over network 106. At step 506, in response to receiving the request for presence information, server 102 determines a live list of a plurality of available provider entities (providers 108) based on the presence status of each one of providers 108 who provide service for the corresponding to the subject matter category as indicated by the specific one of the plurality of presence lists, wherein the live list only includes providers 108 who are presently available. At step 508, server 102 provides client device 112 with the live list. It is to be understood that presence lists 116 may be the live lists or the live lists may be derivatives of presence lists 116 that include only currently available providers 108. At step 510, server 102 receives a selection of a specific provider of providers 108 who are presently available from client device 114. At step 512, at the moment server 102 receives the selection server 102 triggers communication module 204 to establish the live media session between computing device 110 and client device 114 over network 106. At step 514, server 102 alters the presence status of the specific one of the plurality of service provider entities to indicate that the specific one of the plurality of service provider entities is not presently available. At step 516, server 102 updates the live list by removing the provider selected by user 112 and transitioning the remaining providers below the selected provider up the live list.

In one embodiment, server 102 is configured to detect, flag, and analyze components of the communication session by performing one or more tasks in order to provide real-time analytics and associations between components of a transcript and participants in the live communication sessions. For example, provider 108 and user 112 may be discussing a particular subject and provider 108 may suggest one or more tasks during the telecommunication session for user 112 to complete in which server 102 automatically flags the portion of the transcript of the telecommunication session mentioning the one or more tasks, tags the portion of the transcript and/or the one or more tasks as relating to a particular subject or area of interest, and stores the tagged portion and any applicable metadata in database 104. In one embodiment, the tagged portion of the transcript of the telecommunication session is configured to be associated with a specific user of the platform not participating in the telecommunication session. For example, provider 108 and user 112 is advising user 112 on basic legal requirements/compliances associated with start-up companies in which provider 108 suggests that user 112 establish a legal entity and refers a colleague for user 112 that is a corporate attorney, in which server 102 would flag and tag the portion of the transcript in which provider 108 mentions the colleague, associates the contact information of the colleague with the tagged portion of the transcript, and stores the aforementioned in database 104. Server 102 is further configured to provide user 112 with notifications and/or reminders relating to reaching out to and/or contacting the colleague after the session between provider 108 and user 112. It is to be understood that server 102 is configured to perform the flagging, tagging, associating, and organizing of topics, categories, tasks, and individuals mentioned during the telecommunication sessions by parsing the transcript of the telecommunication sessions and extracting relevant information for the transcript in order to perform functions such as, but not limited to setting reminders for user 112 to perform tasks, automatically performing associated tasks (generating and transmitting emails to applicable parties) based on components of the transcript, and utilizing one or more machine learning algorithms in order to make predictions based on the information extracted from the transcript. In one embodiment, server 102 generates a timeline based on the transcript of the telecommunication session and parses the content of the transcript in a manner in which topics, individuals, and tasks are associated and/or allocated to specific segments of the timeline allowing users to analyze data specific to the segments and their associated tags on the timeline. In one embodiment, users performing analysis of the aforementioned data is enabled by one or more supporting graphical user interfaces provided by server 102.

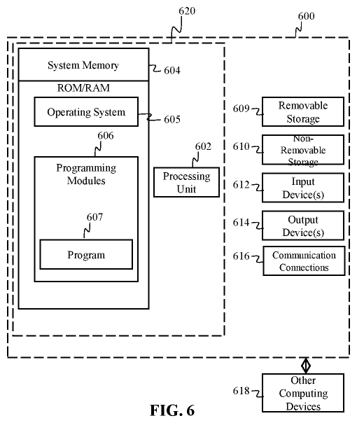

FIG. 6 is a block diagram of a system including an example computing device 600 and other computing devices. Consistent with the embodiments described herein, the aforementioned actions performed by devices 110, 114, and server 102 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for system 100 and processes/methods 400 & 500. Processes 400 & 500, and data related to said processes may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RANI)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of server 102 and devices 110 and 114, for example. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 66 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of the stages of the process 200 as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

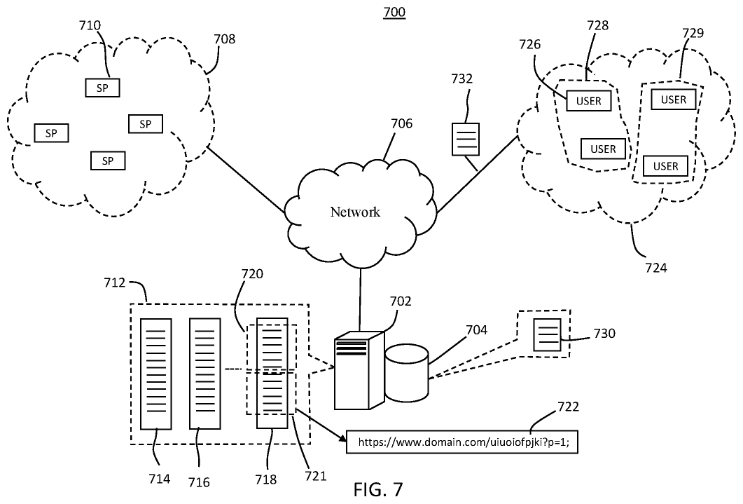

FIG. 7 is a system diagram of an expert communication system 100 for exposing service providers to users in real time which ensures the service providers are seen by at least some users. The phrase “expert communication system” here means a system that allows users to seek out service providers who are experts in certain fields to allow the user to communicate with the service providers to address a specific question or other communications. The system 700 is designed to ensure that the service providers receive exposure to users, in real time, to avoid the problem of users picking only or mostly highly ranked/rated service providers, and then waiting for the service provider to become available or otherwise arranging to communicate at a future time. The system 700 only exposes to users those service providers who presently available to communicate. When a service provider becomes unavailable, such as by entering into a communication session with a user, or by termination of their network session with the system 700, the service provider is removed from exposure, in real time, to the user(s).

The system 700 includes a server 702 that represents computing equipment that receives and response requests received over a network 706. In this context, “requests” are from other computing machines in a network addressable form, such as a uniform resource locator (URL). The server 702 can establish network sessions with other machines, as is known. The server 702 is operably connected to a database 704 in which various user and service provider records can be stored and accessed. The database 704 represents non-volatile storage in which record access can be controlled, preventing simultaneous access by entities in the server 702 where the server 702 can be multiple machines within a data center that process and respond to requests and data from remote machines during network sessions. The server 702 can be accessed by service providers 708 over the network 706. A “service provider,” as used here can refer to a person who provides advice, knowledge, opinions, etc., or a computing machine (e.g. 710) used by that person to engage in communications over the network 706 with other machines, depending on the context. Each of the service providers 710 can “log on” to the server 702 and establish a session. Upon establishing a session, the service provider can provide log on credentials to access their account. Each service provider can indicate, in a way that is stored in a record associated with the service provider in database 704, for example, which subject matter categories they are qualified to provide service for, and their credential for that subject matter, as well as an indication as to whether the credentials have been verified. After a service provider has logged on to the server 702, the server 702 can update one or more presence lists 712 to indicate the service provider is presently available. The presence lists 712 can include specific lists 714, 716, 718 that each relate to a specific subject matter category. The server 702 maintains and updates the presence status of each service provider in real time. Thus, for example, when a service provider's presence status is changed, the server updates the presence status on each presence list in which the service provider is included. The presence lists 712 can be subdivided into subsets 720, 721 of available service providers. Each subset 720, 721 can be provided by the server 702 to different ones of users 724 or different subsets 728 of users. Each user 724, like each service provider 708, uses a remote user client machine 726 to access the server 702 over the network 706.

As an example, a user 724 can use machine 726 to access the server 702. Upon logging into an account for the user that is maintained by the server 702, the user can select or otherwise indicate which subject matter category or categories in which they wish to receive assistance. The indication can be processed by the server, and the server can then determine which presence list or lists to serve to the user. Upon determining which subject matter categories in which the user is interested, the server then serves data 732 to the user's machine (e.g. 726) that can include a script for rendering one or more presence lists at the user's machine, where the script can include a URL 722 that allows the machine (using, for example, a web browser) to access a specific presence list or subset of a presence list. Thus, the server can maintain presence lists, based on service provider status, and users can observe the presence lists in real time. When presence list is changed, the server can send out a change notice to users presently subscribe to the presence list, causing the web browser, via the script, to update the rendered presence list at the user's machine. The rendered presence list(s) can include hyperlinks that allow the user to browse detailed information about each service provider presently included on the rendered presence list, and further a hyperlink to select a service provider for a communication session.

Upon a user selecting a service provider, the server 702 can initiate a private communication session between the user and the service providers, meaning real time communications occur between the service provider machine 710 and the user's machine 726, as facilitated by the service 702. When such a communication session is initiated, the server updates the presence status of the service provider, changing the service provider's status from “available” to “unavailable.” As a result, any presence lists 714, 716, 718 on which the service provider was accessible are updated to remove an indication of the service provider, which in turn causes the rendered presence list(s) at the user machines to be updated, removing the service provider from each rendered presence list at the user machines that had previously shown the service provide being available. In some embodiments, where there may be a large number of users and service providers, the service can serve different subsets 720, 721 of the presence lists to different ones or different subsets 728, 729 of users.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RANI or ROM. Further, the disclosed methods' stages may be modified in any manner, including by reordering stages and/or inserting or deleting stages, without departing from the invention.

A system and method for real time connection of service seekers with online service providers has been disclosed that automatically aggregates, manages, and eliminates service provider data within presence lists in real time while simultaneously hosting live media sessions between users of the system and service providers selected by users of the system. As a service provider is selected by a user, the service provider is removed from the presence list allowing service providers listed below the selected service provider to ascend the presence list increasing the chances of service providers lower on the presence list to be exposed to other users of the system.

The claims appended hereto are meant to cover all modifications and changes within the scope and spirit of the present invention.

1. A computer implemented method performed at a server, comprising:
establishing, by the server in a memory of the server, a plurality of presence lists, wherein each one of the plurality of presence lists corresponds to a respective one of a plurality of defined subject matter categories and indicates a presence status of each one of a plurality of provider entities who provide service corresponding to the subject matter category wherein the presence status indicates whether each provider is available or unavailable;
receiving, at the server, from a plurality of remote user client devices over a network, a plurality of requests, each one of the plurality of requests from a different one of the plurality of remote user client devices for a list of available service providers for one of the plurality of defined subject matter categories;
the server, responsive to receiving the plurality of requests, determining, a plurality of live lists, wherein each one of the plurality of live lists includes a list of a plurality of available provider entities based on the presence status of each one of the plurality of provider entities who provide service for the corresponding subject matter category as indicated by the specific one of the plurality of presence lists, wherein the live list only includes ones of the plurality of service provider entities who are presently available, and wherein each one of the live lists is a subset of available provider entities such that each one of the plurality of service providers is on one of the plurality of live lists;
serving, by the server, to the plurality of remote user client devices, the plurality of live lists such that each one of the plurality of remote user devices is served one list of the plurality of live lists, and the plurality of live lists are distributed among the plurality of remote client user devices to expose each of the available provider entities among the plurality of remote client devices;
receiving, at the server, from one remote user client device of the plurality of remote user client devices, a selection of a specific one of the plurality of service provider entities who are presently available, wherein the specific one of the plurality of service providers is selected from the live list served to the one remote client device;
responsive to receiving the selection of the specific one of the plurality of service provider entities who are presently available, the server establishing a live media session between the remote user client device and the specific one of the plurality of service provider entities;
responsive to establishing the live media session, altering a presence status of the specific one of the plurality of service provider entities to indicate that the specific one of the plurality of service provider entities is not presently available; and
updating the live list to remove the specific one of the plurality of service provider entities.

2. The method of claim 1, wherein determining a live list of a plurality of available provider entities comprises
limiting a number of available provider entities on the live list to a preselected maximum number, and wherein the live list is one of at least two live lists created from the one of the plurality of presence lists, wherein each of the at least two live lists are provided to different remote user client devices.

3. The method of claim 1, wherein establishing the plurality of presence lists comprises:
extracting a plurality of user activity data from the one remote user client device;
determining, based on the plurality of user activity data, a suggestion for the plurality of defined subject matter categories; and
identifying the plurality of provider entities who provide service corresponding to the suggestion for the plurality of defined subject matter categories.

4. The method of claim 1, wherein establishing the plurality of presence lists comprises
determining, via a communication module, if each one of the plurality of provider entities corresponding to the plurality of defined subject matter categories is engaged in the live media session; and
based on the determination, adding the plurality of provider entities to the respective presence list based on a defined subject matter category of the plurality of defined subject matter categories.

5. The method of claim 1, further comprising:
removing a provider entity of the plurality of provider entities from the plurality of presence lists based on detecting, via a communication module, a connection between the remote user client device and at least one computing device associated with a service provider entity of the plurality of service provider entities.

6. (canceled)

7. A method for exposing service providers to users in an expert communication system, comprising:
at a server, maintaining a presence list of a plurality of service providers that indicates, for each one of the plurality of service providers whether the one of the service providers is presently available or unavailable;
defining, by the server, a plurality of subsets of the presence list, each one of the plurality of subsets is a live list of available ones of the plurality of service providers;
receiving, at the server, from a remote user client device, a request for a list of service providers;
in response to the request, the server selecting one of the plurality of subsets;
the server serving a hyperlink to the live list of available service providers in the selected subset to the remote client device with a script that causes the remote client device to update, in real time, a rendered version of the live list of available service providers at the remote client device; and
the server further maintaining, in real time, the live list by removing service providers as they become unavailable and adding service providers as they become available;
wherein, as a result of maintaining the live list, a rendered version of the live list only includes ones of the plurality of service providers who are presently available, and wherein ones of the plurality of service providers who included on the rendered version of the live list and who become subsequently unavailable are removed in real time from the rendered version of the live list.

8. The method of claim 7, wherein:
the presence list is one of a plurality of presence lists, wherein the server maintains each one of the plurality of presence lists for a different subject matter category;
wherein receiving the request for a list of service providers indicates at least two of the plurality of subject matter categories; and
serving the hyperlink to the list of available service providers comprises serving a hyperlink to each of at least two of the plurality of presence lists for each of the at least two subject matter categories.

9. The method of claim 7, further comprising:
receiving, at the server from the remote user client device, a selection of one of the plurality of service providers;
in response to receiving the selection, the server initiating a communication session between the one of the plurality of service providers and the remote user client device; and
changing a presence status of the one of the plurality of service providers to indicate the one of the plurality of service providers is presently unavailable.

10. The method of claim 9, further comprising:
determining, by the server, that the communication session has concluded; and
in response to determining that the communication session has concluded; the server changing the presence status of the one of the plurality of service providers to indicate the one of the plurality of service providers is presently available.

11. A system for real time connection of service seekers with online service providers, comprising:
a server designed and configured to:
establish a plurality of presence lists, wherein each one of the plurality of presence lists corresponds to a respective one of a plurality of defined subject matter categories and indicates a presence status of each one of a plurality of provider entities who provide service corresponding to the subject matter category, wherein the presence status indicates whether each provider is available or unavailable;
receive from a plurality of remote user client devices over a network, a plurality of requests, each one of the plurality of requests from a different one of the plurality of remote user client devices for a list of available service providers for one of the plurality of defined subject matter categories;
determine, responsive to receiving the plurality of requests, a plurality of live lists, wherein each one of the plurality of live lists includes a list of a plurality of available provider entities based on the presence status of each one of the plurality of provider entities who provide service for the corresponding subject matter category as indicated by the specific one of the plurality of presence lists, wherein the live list only includes ones of the plurality of service provider entities who are presently available, and wherein each one of the live lists is a subset of a total of available provider entities such that each one of the plurality of service providers is on one of the plurality of live lists;
serve to the plurality of remote user client devices, the plurality of live lists such that each one of the plurality of remote user devices is served one list of the plurality of live lists, and the plurality of live lists are distributed among the plurality of remote client user devices to expose each of the available provider entities among the plurality of remote client devices;
receive, from one remote user client device of the plurality of remote user client devices, a selection of a specific one of the plurality of service provider entities who are presently available, wherein the specific one of the plurality of service providers is selected from the live list served to the one remote client device;
establish, responsive to receiving the selection of the specific one of the plurality of service provider entities who are presently available, a live media session between the remote user client device and the specific one of the plurality of service provider entities;
responsive to establishing the live media session, alter a presence status of the specific one of the plurality of service provider entities to indicate that the specific one of the plurality of service provider entities is not presently available; and
update the live list to remove the specific one of the plurality of service provider entities.

12. The system of claim 11, wherein determining a live list of a plurality of available provider entities comprises limiting a number of available provider entities on the live list to a preselected maximum number, and wherein the live list is one of at least two live lists created from the one of the plurality of presence lists, wherein each of the at least two live lists are provided to different remote user client devices.

13. The system of claim 11, wherein establishing the plurality of presence lists comprises
extracting a plurality of user activity data from the remote user client device;
determining, based on the plurality of user activity data, a suggestion for the plurality of defined subject matter categories; and
identifying the plurality of provider entities who provide service corresponding to the suggestion for the plurality of defined subject matter categories.

14. The system of claim 11, further comprising:
a communication module designed and configured to:
determine if each one of the plurality of provider entities corresponding to the plurality of defined subject matter categories is engaged in the live media session; and
based on the determination, adding the plurality of provider entities to the respective presence list based on a defined subject matter category of the plurality of defined subject matter categories.

15. The system of claim 14, wherein the server is further configured to:
remove a provider entity of the plurality of provider entities from the plurality of presence lists based on detecting, via the communication module, a connection between the remote user client device and at least one computing device associated with a service provider entity of the plurality of service provider entities.

16. (canceled)

17. A system for exposing service providers to users in an expert communication system, comprising:
a server including a processor that is designed and configured to:
maintain, at the server, a presence list of a plurality of service providers that indicates, for each one of the plurality of service providers whether the one of the service providers is presently available or unavailable;
define a plurality of subsets of the presence list, each one of the plurality of subsets is a live list of available ones of the plurality of service providers;
receive, at the server, from a remote user client device, a request for a list of service providers;
in response to the request, select one of the plurality of subsets;
serve a hyperlink to the live list of available service providers in the selected subset to the remote client device with a script that cause the remote client device to update, in real time, a rendered version of the live list of available service providers at the remote client device; and
maintain, in real time, the available presence list by removing service providers as they become unavailable and adding service provider as they become available;
wherein, as a result of maintaining the live list, a rendered version of the live list only includes ones of the plurality of service providers who are presently available, and wherein ones of the plurality of service providers who included on the rendered version of the live list and who become subsequently unavailable are removed in real time from the rendered version of the live list.

18. The system of claim 17, wherein:
the presence list is one of a plurality of presence lists, wherein the server maintains each one of the plurality of presence lists for a different subject matter category;
wherein receiving the request for a list of service providers indicates at least two of the plurality of subject matter categories; and
serving the hyperlink to the list of available service providers comprises serving a hyperlink to each of at least two of the plurality of presence list s for each of the at least two subject matter categories.

19. The system of claim 17, wherein the server is further configured to:
receive, from the remote user client device, a selection of one of the plurality of service providers;
in response to receiving the selection, initiate a communication session between the one of the plurality of service providers and the remote user client device; and
change a presence status of the one of the plurality of service providers to indicate the one of the plurality of service providers is presently unavailable.

20. The system of claim 19, wherein the server is further configured to:
determine that the communication session has concluded; and
in response to determining that the communication session has concluded; change the presence status of the one of the plurality of service providers to indicate the one of the plurality of service providers is presently available.
